(19) United States
(12) Patent Application Publication
(10) Pub. No.: US 2010/0104968 A1
(43) Pub. Date: Apr. 29, 2010

(54) Polymerized toner having high resolution

(76) Inventors: Dong Jin Park, Daejeon (KR); Chang Soon Lee, Daejeon (KR); Wook Jang, Daejeon (KR); Yu Na Kim, Daejeon (KR); Jung Woo Kim, Daejeon (KR)

Correspondence Address: MCKENNA LONG & ALDRIDGE LLP, 1900 K STREET, NW, WASHINGTON, DC, 20006, US

(21) Appl. No.: 12/588,693

(22) Filed: Oct. 23, 2009

(30) Foreign Application Priority Data
Oct. 24, 2008 (KR) 10-2008-0104497
Oct. 19, 2009 (KR) 10-2009-0099081

(51) Int. Cl. G03G 9/093; G03G 9/09; G03G 9/08; G03G 9/087

(52) U.S. Cl. 430/108.23; 430/108.1; 430/108.2; 430/108.4; 430/108.5; 430/108.6; 430/108.7; 430/108.8; 430/109.3; 430/109.4; 430/110.2

(57) ABSTRACT

A polymerized toner is provided. The polymerized toner comprises a reactive anionic surfactant having at least one reactive functional group. The reactive anionic surfactant is added simultaneously with a dispersant to prepare an aqueous dispersion or is added within 2 hour after a polymerization reaction of a monomer mixture is initiated in an aqueous dispersion. This simultaneous or rapid addition allows the reactive anionic surfactant to be dispersed on the surface of the toner particles. The reactive anionic surfactant is located over the entire surface of the toner particles to increase the surface charge density of the toner, achieving good charge stability and excellent imaging characteristics.

### BACKGROUND OF THE INVENTION

1. Field of the Invention

The present invention relates to a polymerized toner with good charge stability and excellent imaging characteristics that is produced by suspension polymerization. More specifically, the present invention relates to a polymerized toner that is produced using a reactive anionic surfactant having at least one reactive functional group wherein the reactive anionic surfactant is located over the entire surface of the toner particles to increase the surface charge density of the toner, achieving good charge stability and excellent imaging characteristics.

2. Description of the Related Art

Generally, toners are used for the development of electrophotographic images and in electrostatic printers, copiers, etc. Toners refer to coating substances that are used to develop images on suitable substrates during transfer. In recent years, there has been an increasing need to print color images using imaging devices, such as multifunction printers, facsimiles and printers, based on electrophotography. In addition, color printing is needed to print images (e.g., photographs) requiring high resolution and clear color reproduction. To meet these needs, the use of color toners is required.

Numerous methods have been developed for the production of toners. According to a most widely known melt-mixing process, a resin and a pigment are melt-mixed or extruded, pulverized and classified to obtain toner particles. However, the toner particles have a broad diameter distribution and are very irregular in shape (e.g., sharp-edged), which are disadvantageous in terms of charging characteristics and flowability.

To overcome the above disadvantages, methods for the production of spherical toner particles based on polymerization have been proposed. It is known that the methods can be carried out by emulsion polymerization and suspension polymerization. Toners produced by emulsion polymerization are very harmful to humans when being inhaled due to their very small diameter. For this reason, suspension polymerization is currently used in preference to emulsion polymerization.

Many techniques are known for producing polymerized toners by suspension polymerization. For example, U.S. Pat. No. 6,337,169 suggests that since a wax is melted at a high rate when a portion of a pigment is dissolved in the wax, the pigment and the wax can rapidly form images when a toner is fused at a high temperature, ensuring high quality of the images. However, high quality of the images is dependent on the charge density of the final toner rather than dependent on the position and concentration of the pigment. That is, even when a larger amount of the pigment is dispersed in a binder, a low charge density of the toner cannot achieve high quality of the images.

That is, there is a continuing need to increase the surface charge density of toners in order to form high-quality images. According to a general method for producing toner particles, a charge control agent or resin is dissolved or uniformly dispersed in one or more monomers, followed by polymerization to impart sufficient charges to final toner particles. However, the charge control agent is non-uniformly distributed on the toner surface because of its poor compatibility with the toner resin, and as a result, an increase in the amount of electric charge of the toner is insignificant. Under these circumstances, there is a need to develop an efficient method for increasing the surface charge density of toners.

### SUMMARY OF THE INVENTION

Therefore, the present invention has been made in an effort to solve the problems of the prior art, and it is an object of the present invention to provide a polymerized toner whose surface charge density is sufficiently high to form high-quality images.

It is another object of the present invention to provide a polymerized toner that has good charge stability and excellent imaging characteristics due to its high surface charge density.

The present inventors have conducted research on a method for increasing the surface charge density of a toner, and as a result, have found that when a reactive anionic surfactant having at least one reactive functional group was used in the production of a toner, the reactive anionic surfactant was located over the entire surface of the toner particles to increase the surface charge density of the toner. The present inventors have also found that this structural characteristic was maximized when the reactive anionic surfactant was used simultaneously with a dispersant to prepare an aqueous dispersion or it was used within 2 hours after a polymerization reaction of a monomer mixture was initiated in an aqueous dispersion. The present invention has been accomplished based on these findings.

According to an aspect of the present invention, there is provided a polymerized toner comprising a reactive anionic surfactant having at least one reactive functional group wherein the reactive anionic surfactant is added in the initial stage of the polymerization of one or more monomers and is dispersed on the surface of the toner particles after the polymerization.

### DETAILED DESCRIPTION OF THE INVENTION

Exemplary embodiments of the present invention will now be described in detail.

The present invention provides a polymerized toner that is produced by suspension polymerization of one or more binder resin monomers, a molecular weight modifier, a wax, a dispersant, a polar grafting agent, a pigment, and a reactive anionic surfactant having at least one reactive functional group.

The reactive functional group may be selected from allyl, (meth)acryloyl and propenyl groups.

The reactive anionic surfactant has a polar functional group selected from the group consisting of carboxyl, sulfonate and sulfate groups.

The reactive anionic surfactant having an allyl group as the reactive functional group is typified by a sulfate salt of polyoxyethylene allylglycidyl nonylphenyl ether, and examples thereof include ADEKAEIA SOAP SE series commercially available from Asahi Denka.

A commercial available product of the reactive anionic surfactant having a (meth)acryloyl group as the reactive function group is ELEMINOL RS 3000 (Sanyo Kasei).

A representative example of the reactive anionic surfactant having a propenyl group as the reactive functional group is an ammonium sulfate salt of polyoxyethylene allylglycidyl nonylpropenylphenyl ether, and examples thereof include AQUARON HS-05, HS-10, HS-20 and HS-30 commercially available from Daiichi Kogyo Seiyaku and LATEMUL ASK commercially available from KAO.

It is preferred to add the reactive anionic surfactant simultaneously with the dispersant to prepare an aqueous dispersion or add the reactive anionic surfactant in the initial stage of the polymerization of the binder resin monomers, for example, within 2 hr after a polymerization reaction of a monomer mixture substantially proceeds in an aqueous dispersion.

The reactive anionic surfactant may be added simultaneously with the dispersant to prepare an aqueous dispersion. In this case, the content of the reactive anionic surfactant in the aqueous dispersion is preferably 0.1 to 2% by weight. The use of the reactive anionic surfactant in an amount of 0.1 to 2% by weight prevents the toner particles from being excessively reduced in size while increasing the surface charge density of the toner.

Alternatively, the reactive anionic surfactant may be added within 2 hr after a polymerization reaction of a monomer mixture substantially proceeds in an aqueous dispersion containing the dispersant. In this case, the reactive anionic surfactant is preferably added in an amount of 0.1 to 2% by weight, based on the weight of the aqueous dispersion.

The reactive functional group of the reactive anionic surfactant offers a reaction site where the reactive anionic surfactant can react with the toner particles to form chemical bonds on the surface of the toner particles. This chemical bonding allows the reactive anionic surfactant to be present on the surface of the toner particles without being removed during subsequent washing/drying. Further, the polar functional group of the surfactant distributed over the entire surface of the toner particles can play a role in improving the charging characteristics of the toner particles.

The use of the reactive anionic surfactant in an amount of 0.1 to 2% by weight prevents the toner particles from being excessively reduced in size while increasing the surface charge density of the toner.

In the case where the reactive anionic surfactant is added within 2 hr after a polymerization reaction of a monomer mixture is initiated, the reactive anionic surfactant is preferably added in an amount of 0.1 to 2% by weight, based on the weight of the monomer mixture.

The constituent binder resin monomers of the polymerized toner according to the present invention may be selected from the group consisting of a vinyl aromatic monomer, an acrylic monomer, a diene monomer, an acidic olefin monomer and a basic olefin monomer.

The vinyl aromatic monomer is selected from the group consisting of styrene, monochlorostyrene, methylstyrene, and dimethylstyrene. The vinyl aromatic monomer is preferably present in an amount of 30 to 90 parts by weight, based on the total weight of the monomer mixture.

The acrylic monomer is selected from the group consisting of methyl acrylate, ethyl acrylate, n-butyl acrylate, isobutyl acrylate, dodecyl acrylate, 2-ethylhexyl acrylate, methyl methacrylate, ethyl methacrylate, n-butyl methacrylate, isobutyl methacrylate, dodecyl methacrylate, and 2-ethylhexyl methacrylate. The diene monomer is selected from the group consisting of butadiene and isoprene. Each of the acrylic monomer and the diene monomer is preferably used in an amount of 5 to 70 parts by weight, based on the weight of all the binder resin monomers.

The acidic olefin monomer is selected from the group consisting of α,β-ethylenically unsaturated compounds having at least one carboxyl group. The basic olefin monomer is selected from the group consisting of methacrylic acid esters, methacrylamides and vinylamines of aliphatic alcohols having at least one amine group or quaternary ammonium group, and ammonium salts thereof. Each of the acidic and basic olefin monomers is preferably used in an amount of 30 parts by weight or less, based on the weight of all the binder resin monomers.

The molecular weight modifier is selected from the group consisting of mercaptan compounds, such as t-dodecyl mercaptan and n-dodecyl mercaptan, and mixtures thereof. The molecular weight modifier is preferably used in an amount of 0.001 to 8.000 parts by weight, based on the weight of all the binder resin monomers.

The wax is selected from the group consisting of: petroleum waxes, including paraffin wax, microcrystalline wax and ceresin wax; natural waxes, including carnauba wax; synthetic waxes, including polyethylene wax and polypropylene wax; and mixtures thereof. The wax is preferably used in an amount of 30 parts by weight or less, based on the weight of all the binder resin monomers.

The dispersant is selected from the group consisting of: inorganic dispersants, including silica, insoluble calcium salts and insoluble magnesium salts; anionic surfactants, including fatty acid salts, alkyl sulfate, alkylaryl sulfate, dialkyl sulfosuccinate, and alkyl phosphate; non-ionic surfactants, including polyoxyethylene alkyl ether, polyoxyalkylene alkylphenol ether, sorbitan fatty acid ester, polyoxyalkylene fatty acid ester, glycerin fatty acid ester, polyvinyl alcohol, alkyl cellulose, and polyvinyl pyrrolidone; and ionic polymer dispersants including polyacrylamide, polyvinylamine, polyvinylamine N-oxide, polyvinyl ammonium salts, polydialkyldiallyl ammonium salts, polyacrylic acid, polystyrene sulfonic acid, polyacrylate, polystyrene sulfonate, and polyaminoalkyl acrylate. The dispersant is preferably used in an amount of 0.001 to 20 parts by weight, based on the total weight of the aqueous dispersion.

The polar grafting agent is selected from the group consisting of ethylene dimethacrylate, ethylene glycol dimethacrylate, diethylene glycol diacrylate, 1,6-hexamethylene diacrylate, allyl methacrylate, 1,1,1-trimethylolpropane triacrylate, triallylamine, tetraallyloxyethane, and mixtures thereof. The polar grafting agent is preferably used in an amount of 0.001 to 10 parts by weight, based on the weight of all the binder resin monomers.

The pigment is selected from the group consisting of: inorganic pigments, including metal powder, metal oxide, carbon, sulfide, chromate and ferrocyanide pigments; organic pigments, including azo dye, acidic dye, basic dye, mordant dye, phthalocyanine, quinacridone and dioxane pigments; and mixtures thereof. The pigment is used in an amount of 1 to 100 parts by weight, based on the weight of all the binder resin monomers.

On the other hand, the polymerized toner of the present invention is produced by suspension polymerization. Specifically, the polymerized toner of the present invention is produced by a method comprising the following steps: adding the dispersant to an aqueous medium to prepare an aqueous dispersion; mixing the binder resin monomers, the pigment, the wax, the polar grafting agent, the molecular weight modifier in the presence of a polymerization initiator to prepare a monomer mixture; and reacting the binder resin monomers in the aqueous dispersion.

First, the dispersant is dispersed in an aqueous medium. The dispersant is added in an amount of 0.001 to 20 parts by weight, based on the weight of the aqueous solution.

As explained earlier in detail, the reactive anionic surfactant may be added simultaneously with the dispersant to prepare the aqueous dispersion. Alternatively, the reactive anionic surfactant may be added within 2 hr after the reaction of the monomer mixture substantially proceeds in the aqueous dispersion. In either case, the reactive anionic surfactant is located over the entire surface of the toner particles to effectively increase the surface charge density of the toner.

Then, the vinyl aromatic monomer, the acrylic or diene monomer, and optionally the acidic or basic olefin monomer as the binder resin monomers are mixed with 1 to 20 parts by weight of the pigment, 30 parts by weight or less of the wax, 0.0001 to 10 parts by weight of the polar grafting agent, 0.001 to 8.000 parts by weight of the molecular weight modifier and 0.01 to 5 parts by weight of the reaction initiator, based on the weight of all the binder resin monomers to prepare the monomer mixture. At this time, the vinyl aromatic monomer, the acrylic or diene monomer and the acidic or basic olefin monomer are used in amounts of 30 to 90 parts by weight, 5 to 70 parts by weight and 30 parts by weight or less, respectively, based on the total weight of the monomer mixture.

The reaction initiator is preferably selected from the group consisting of: azo initiators, including azobisisobutyronitrile and azobisvaleronitrile; and oil soluble initiators, including benzoyl peroxide and lauroyl peroxide as organic peroxides.

1 to 60 parts by weight of the monomer mixture is mixed with 100 parts by weight of the aqueous dispersion. The monomer mixture is polymerized while applying a shear force to the mixture to produce a toner.

The dispersant is removed from the solution containing the toner by a suitable process. Washing and filtration are repeated to separate the toner from the solution. The toner is dried in a vacuum oven at room temperature for 48 hr (“post processing”).

Hereinafter, the present invention will be explained in more detail with reference to the following examples. However, these examples are provided for illustrative purposes only and the present invention is not limited thereto.

### EXAMPLES

### Example 1

10 g of colloidal silica as a dispersant and 0.5 g of polyoxyethylene alkylphenyl ether ammonium sulfate (HS-20, Daiichi Kogyo Seiyaku) as a reactive anionic surfactant having a reactive functional group were dissolved in 400 g of distilled water in a 500 ml reactor. The mixture was heated to a reaction temperature of 70° C. to prepare an aqueous dispersion.

160 g of styrene, 36 g of butyl acrylate and 4 g of acrylic acid as monomers, 4 g of allyl methacrylate as a polar grafting agent, 0.02 g of n-dodecyl mercaptan as a molecular weight modifier and 10 g of a cyan pigment were stirred in a bead mill at 2,000 rpm for 2 hr. The beads were removed from the monomer/pigment mixture. After 105 g of the monomer/pigment mixture was heated in a water bath at 70° C., 5 g of paraffin wax was added thereto. The monomer mixture was sufficiently dissolved with stirring for 20 min. To the solution was added 2 g of azobisisobutyronitrile as a polymerization initiator, followed by stirring for 5 min.

410.5 g of the aqueous dispersion and 112 g of the monomer mixture were mixed together, and the reaction was continued with stirring using a homogenizer at 10,000 rpm for 20 min and successively a general stirrer at 600 rpm for 15 hr to produce a toner.

### Example 2

A toner was produced in the same manner as in Example 1, except that 0.5 g of potassium alkyl succinate sulfate (ASK, KAO) as a reactive anionic surfactant was used.

### Example 3

A toner was produced in the same manner as in Example 1, except that 0.5 g of ELEMINOL RS 3000 (Sanyo Kasei) was used as a reactive anionic surfactant.

### Example 4

A toner was produced in the same manner as in Example 1, except that 0.5 g of ADEKAEIA SOAP SE10-N (Asahi Denka) was used as a reactive anionic surfactant.

### Example 5

A toner was produced in the same manner as in Example 1, except that an aqueous dispersion was prepared without using the reactive anionic surfactant (HS-20), and instead 0.4 g of the reactive anionic surfactant (HS-20) was added all at one time 1 hr after the polymerization reaction of the monomer mixture was substantially initiated in the aqueous dispersion and then the reaction was continued for 10 hr.

### Comparative Example 1

A toner was produced in the same manner as in Example 1, except that an aqueous dispersion was prepared without using the reactive anionic surfactant (HS-20), and instead 0.4 g of the reactive anionic surfactant (HS-20) was added all at one time 5 hr after the polymerization reaction of the monomer mixture was substantially initiated in the aqueous dispersion and then the reaction was continued for 10 hr.

### Comparative Example 2

10 g of colloidal silica as a dispersant was dissolved in 400 g of distilled water in a 500 ml reactor. The mixture was heated to a reaction temperature of 70° C. to prepare an aqueous solution.

160 g of styrene, 36 g of butyl acrylate and 4 g of acrylic acid as monomers, 4 g of allyl methacrylate as a polar grafting agent, 0.02 g of n-dodecyl mercaptan as a molecular weight modifier and 10 g of a cyan pigment were stirred in a bead mill at 2,000 rpm for 2 hr. The beads were removed from the monomer/pigment mixture.

After 105 g of the monomer/pigment mixture was heated in a water bath at 70° C., 1 g of a styrene-acrylic polymer having sulfonic acid groups as a charge control agent and 5 g of paraffin wax was added thereto. The monomer mixture was sufficiently dissolved with stirring for 20 min. To the solution was added 2 g of azobisisobutyronitrile as a polymerization initiator, followed by stirring for 5 min. The reaction mixture was added to the aqueous solution. The reaction was continued with stirring using a homogenizer at 10,000 rpm for 20 min and successively a general stirrer at 600 rpm for 15 hr to produce a toner.

### Comparative Example 3

10 g of colloidal silica as a dispersant was dissolved in 400 g of distilled water in a 500 ml reactor. The mixture was heated to a reaction temperature of 70° C. to prepare an aqueous solution.

160 g of styrene, 36 g of butyl acrylate and 4 g of acrylic acid as monomers, 4 g of allyl methacrylate as a polar grafting agent, 0.02 g of n-dodecyl mercaptan as a molecular weight modifier and 10 g of a cyan pigment were stirred in a bead mill at 2,000 rpm for 2 hr. The beads were removed from the monomer/pigment mixture.

After 105 g of the monomer/pigment mixture was heated in a water bath at 70° C., 5 g of paraffin wax was added thereto. The monomer mixture was sufficiently dissolved with stirring for 20 min. To the solution was added 2 g of potassium persulfate as a polymerization initiator, followed by stirring for 5 min. The reaction mixture was added to the aqueous solution. The reaction was continued with stirring using a homogenizer at 10,000 rpm for 20 min and successively a general stirrer at 600 rpm for 15 hr to produce a toner.

### Test Example 1

Each of the toners produced in Examples 1-5 and Comparative Examples 1-3 was mixed with 2 parts by weight of surface-modified silica (RY200S) in a blender at 3,000 rpm for 3 min to modify the surface of the toner. The amount of electric charge of the toner was measured in a printer (HP4600) by a suction method. The results are shown in Table 1.

TABLE 1

| | | Amount of electric |
|---|---|---|
| Sample No. | Transfer rate (%) | charge (μC/g) |
| Example 1 | 97 | −45 |
| Example 2 | 95 | −44 |
| Example 3 | 95 | −42 |
| Example 4 | 96 | −43 |
| Example 5 | 96 | −41 |
| Comparative Example 1 | 80 | −30 |
| Comparative Example 2 | 85 | −25 |
| Comparative Example 3 | 70 | −20 |

As can be seen from Table 1, the toners of Examples 1-5 had high transfer rates and large amounts of electric charge, compared to the toners of Comparative Examples 1-3. Particularly, in the production of each of the toners in Examples 1-5, the use of the reactive anionic surfactant in the initial stage of the polymerization reaction resulted in an improvement in surface charge density.

As is apparent from the foregoing, according to the present invention, the reactive anionic surfactant having at least one reactive functional group is located over the entire surface of the toner particles to increase the surface charge density of the toner, achieving good charge stability and excellent imaging characteristics. In contrast, a conventional toner has a low surface charge due to poor compatibility between a charge control agent and a binder resin.

What is claimed is:

1. A polymerized toner comprising a reactive anionic surfactant having at least one reactive functional group wherein the reactive anionic surfactant is added in the initial stage of the polymerization of one or more monomers and is dispersed on the surface of the toner particles after the polymerization.

2. The polymerized toner of claim 1, wherein the reactive functional group is selected from the group consisting of allyl, (meth)acryloyl and propenyl groups.

3. The polymerized toner of claim 2, wherein the reactive anionic surfactant having an allyl group is selected from the group consisting of sulfate salts of polyoxyethylene allylglycidyl nonylphenyl ether and mixtures thereof.

4. The polymerized toner of claim 2, wherein the reactive anionic surfactant having a (meth)acryloyl group is selected from the group consisting of ELEMINOL RS series compounds and mixtures thereof.

5. The polymerized toner of claim 2, wherein the reactive anionic surfactant having a propenyl group is selected from the group consisting of ammonium sulfate salts of polyoxyethylene allylglycidyl nonylpropenylphenyl ether and mixtures thereof.

6. The polymerized toner of claim 1, wherein the reactive anionic surfactant has a polar functional group selected from the group consisting of carboxyl, sulfonate and sulfate groups.

7. The polymerized toner of claim 1, wherein the reactive anionic surfactant is previously added to an aqueous dispersion or is added within 2 hour after a polymerization reaction of a monomer mixture is substantially initiated in an aqueous dispersion.

8. The polymerized toner of claim 7, wherein the reactive anionic surfactant is added in an amount of 0.1 to 2% by weight, based on the weight of the aqueous dispersion, when it is previously added to an aqueous dispersion.

9. The polymerized toner of claim 7, wherein the reactive anionic surfactant is added in an amount of 0.1 to 2% by weight, based on the weight of the monomer mixture, when it is added within 2 hour after a polymerization reaction of a monomer mixture is substantially initiated in an aqueous dispersion.

10. The polymerized toner of claim 1, wherein the toner is produced by suspension polymerization.

11. The polymerized toner of claim 1, wherein the toner comprises one or more binder resin monomers, a molecular weight modifier, a wax, a dispersant, a polar grafting agent, a pigment, and a polymerization initiator.

12. The polymerized toner of claim 11, wherein the binder resin monomers are selected from the group consisting of vinyl aromatic monomers, acrylic monomers, diene monomers, acidic olefin monomers and basic olefin monomers.

13. The polymerized toner of claim 11, wherein the molecular weight modifier is selected from the group consisting of t-dodecyl mercaptan, n-dodecyl mercaptan, and mixtures thereof.

14. The polymerized toner of claim 11, wherein the wax is selected from the group consisting of: petroleum waxes, including paraffin wax, microcrystalline wax and ceresin wax; natural waxes, including carnauba wax; synthetic waxes, including polyethylene wax and polypropylene wax; and mixtures thereof.

15. The polymerized toner of claim 11, wherein the dispersant is selected from the group consisting of: inorganic dispersants, including silica, insoluble calcium salts and insoluble magnesium salts; anionic surfactants, including fatty acid salts, alkyl sulfate, alkylaryl sulfate, dialkyl sulfosuccinate, and alkyl phosphate; non-ionic surfactants, including polyoxyethylene alkyl ether, polyoxyalkylene alkylphenol ether, sorbitan fatty acid ester, polyoxyalkylene fatty acid ester, glycerin fatty acid ester, polyvinyl alcohol, alkyl cellulose, and polyvinyl pyrrolidone; ionic polymer dispersants including polyacrylamide, polyvinylamine, polyvinylamine N-oxide, polyvinyl ammonium salts, polydialkyldiallyl ammonium salts, polyacrylic acid, polystyrene sulfonic acid, polyacrylate, polystyrene sulfonate, and polyaminoalkyl acrylate; and
mixtures thereof.

16. The polymerized toner of claim 11, wherein the polar grafting agent is selected from the group consisting of ethylene dimethacrylate, ethylene glycol dimethacrylate, diethylene glycol diacrylate, 1,6-hexamethylene diacrylate, allyl methacrylate, 1,1,1-trimethylolpropane triacrylate, triallylamine, tetraallyloxyethane, and mixtures thereof.

17. The polymerized toner of claim 11, wherein the pigment is selected from the group consisting of: inorganic pigments, including metal powder, metal oxide, carbon, sulfide, chromate and ferrocyanide pigments; organic pigments, including azo dye, acidic dye, basic dye, mordant dye, phthalocyanine, quinacridone and dioxane pigments; and mixtures thereof.
